(19) United States
(12) Patent Application Publication
(10) Pub. No.: US 2024/0331953 A1
(43) Pub. Date: Oct. 3, 2024

(54) LARGE FORMAT AQUEOUS CARBON CAPACITOR FOR GRID-SCALE ENERGY STORAGE

(71) Applicant: CapyBara Energy, LLC, Seabrook, NH (US)

(72) Inventors: Matthew D. Millard, Medford, MA (US); Dan Danila, Sharon, MA (US)

(21) Appl. No.: 18/190,508

(22) Filed: Mar. 27, 2023

(51) Int. Cl. H01G 11/12; H01G 11/08; H01G 11/26; H01G 11/32; H01G 11/52; H01G 11/62; H01G 11/68; H01G 11/70; H01G 11/80; H01G 11/82

(52) U.S. Cl. CPC H01G 11/12; H01G 11/08; H01G 11/26; H01G 11/32; H01G 11/52; H01G 11/62; H01G 11/68; H01G 11/70; H01G 11/80; H01G 11/82

(57) ABSTRACT

Disclosed herein is a supercapacitor cell apparatus, a stacked capacitor, and a system for large scale energy storage. The supercapacitor cell includes a first non-metallic current collector, a second non-metallic current collector, a first non-metallic electrode disposed adjacent to the first non-metallic current collector, a second non-metallic electrode disposed adjacent to the second non-metallic current collector, a separator disposed between the first non-metallic electrode and the second non-metallic electrode, and an electrolyte solution disposed between the first non-metallic current collector and the second non-metallic current collector.

### FIELD

The present disclosure generally relates to energy storage and, more specifically, to aqueous carbon-based symmetric electrical double-layer capacitors (EDLC).

### BACKGROUND

Energy storage systems that depend on the electrical double-layer capacitance (EDLC), such as supercapacitors, electrochemical supercapacitors, and the like, have been widely proposed for large-scale energy storage applications. Various capacitor designs, including supercapacitors, have been considered for this purpose. Compared to other types of EDLC energy storage systems, aqueous-electrolyte supercapacitors can be advantageous, particularly for large-scale applications, due to their manufacturability, inherent safety, and low cost realized at grid-scale.

EDLC capacitors generally include a negative electrode, negative active material, positive active material, and a positive active electrode. There is a corresponding electrolyte solution providing ions that migrate from one side to the other during charge or discharge. The charging and discharging follow the physical principles of the electrical double layer. The positive and negative materials are separated by a separator or membrane that allow ions to migrate from one side to the other but separates the two materials from short circuiting. The active materials for a symmetric carbon-based supercapacitor vary widely but are typically based on high surface area carbon, such as activated carbon.

Historically, EDLC capacitors have taken a backseat to batteries regarding grid-scale energy storage due to cost and energy density constraints. Recent advancements in material processing, manufacturing, and a climate positive economy lends credence to employing supercapacitors in grid-scale applications. These recent advancements combined with the known recursive advantages of supercapacitors, such as material safety, simplicity, longevity, reliability, and efficiency, have effectively positioned supercapacitors to be a prime contender for grid-storage technology. Classically, supercapacitors find use with high power and short duration applications, less than 1-hour, e.g., power quality ride-through, power stabilization, adjustable speed drive support, temporary support of distributed resources during load steps, and voltage flicker mitigation. The various types of high-performance supercapacitors seem to meet the requirements of these niche applications. However, for large-scale energy storage, most of these technologies suffer from high-cost, material safety concerns, and/or short duration (less than 1 hour); thereby weakening the argument for supercapacitors being a viable option for grid-scale energy storage.

### SUMMARY

The subject matter of the present application has been developed in response to the present state of the art, and in particular, in response to the shortcomings of current battery/capacitor systems, that have not yet been fully solved by currently available techniques. Accordingly, the subject matter of the present application has been developed to provide apparatus, systems, and methods that overcome at least some of the above-discussed shortcomings of prior art techniques.

The following is a non-exhaustive list of examples, which may or may not be claimed, of the subject matter, disclosed herein.

In one example, a supercapacitor cell includes a first non-metallic current collector, a second non-metallic current collector, a first non-metallic electrode disposed adjacent to the first non-metallic current collector, a second non-metallic electrode disposed adjacent to the second non-metallic current collector, a separator disposed between the first non-metallic electrode and the second non-metallic electrode, and an electrolyte solution disposed between the first non-metallic current collector and the second non-metallic current collector.

In another example, a stacked capacitor includes a plurality of bipolar cells, a first monopolar assembly, a second monopolar assembly, a plurality of separators, and an electrolyte solution. Each of the bipolar cells includes a first non-metallic current collector, a first non-metallic electrode disposed adjacent to the first non-metallic current collector, and a second non-metallic electrode disposed adjacent to the second non-metallic current collector. The first monopolar assembly includes a second non-metallic current collector and a third non-metallic electrode disposed adjacent to the third non-metallic current collector. The second monopolar assembly includes a third non-metallic current collector and a fourth non-metallic electrode disposed adjacent to the fourth non-metallic current collector. A first one of the plurality of separators is disposed between the first non-metallic electrode and the second non-metallic electrode of adjacently stacked bipolar cells or between the first non-metallic electrode and the third non-metallic electrode. A second one of the plurality of separators is disposed between the second non-metallic electrode or the first non-metallic electrode and the third non-metallic electrode or the fourth non-metallic electrode. The electrolyte solution is disposed around the first non-metallic electrode, the second non-metallic electrode, the third non-metallic electrode, and the fourth non-metallic electrode.

In still another example, a system includes a controller, a plurality of stacked capacitors coupled in parallel or series, and a switch in signal communication with the controller and electrically connected between the plurality of stacked capacitors and an electrical load or an energy source. Each one of the plurality of stacked capacitors includes a plurality of bipolar cells, a first monopolar assembly, a second monopolar assembly, a plurality of separators, and an electrolyte solution. The bipolar cells includes a first non-metallic current collector, a first non-metallic electrode disposed adjacent to the first non-metallic current collector, and a second non-metallic electrode disposed adjacent to the second non-metallic current collector. The first monopolar assembly includes a second non-metallic current collector and a third non-metallic electrode disposed adjacent to the third non-metallic current collector. The second monopolar includes a third non-metallic current collector and a fourth non-metallic electrode disposed adjacent to the fourth non-metallic current collector. The plurality of separators includes a first one of the plurality of separators disposed between the first non-metallic electrode and the second non-metallic electrode of adjacently stacked bipolar cells or between the first non-metallic electrode and the third non-metallic electrode and a second one of the plurality of separators disposed between the second non-metallic electrode or the first non-metallic electrode and the third non-metallic electrode or the fourth non-metallic electrode. The electrolyte solution is disposed around the first non-metallic electrode, the second non-metallic electrode, the third non-metallic electrode, and the fourth non-metallic electrode.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is schematic block diagram of an exemplary power storage system, according to one or more examples of the present disclosure;

FIG. 2 is a perspective view of housings for storing capacitor components, according to one or more examples of the present disclosure;

FIG. 3 is a perspective see-through view of a single housing with clamping device for storing capacitor components, according to one or more examples of the present disclosure;

FIG. 4 is a cross-sectional view of a capacitor cell, according to one or more examples of the present disclosure;

FIG. 5 is a cross-sectional view of a bipolar assembly, according to one or more examples of the present disclosure;

FIG. 6 is a cross-sectional view of a monopolar assembly, according to one or more examples of the present disclosure;

FIG. 7 is a cross-sectional view of a stack of capacitor cells, according to one or more examples of the present disclosure;

FIG. 8 is a cross-sectional view of a capacitor cell, according to one or more examples of the present disclosure;

FIG. 9 is a cross-sectional view of a monopolar assembly, according to one or more examples of the present disclosure;

FIG. 10 is a cross-sectional view of a stack of capacitor cells, according to one or more examples of the present disclosure; and

FIG. 11 is a schematic block diagram of a capacitor apparatus, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

It is also to be appreciated that certain features of the present disclosure may be described herein in the context of separate embodiments for clarity purposes, but may also be provided in combination with one another in a single embodiment. That is, unless obviously incompatible or specifically excluded, each individual embodiment is deemed to be combinable with any other embodiment(s) and the combination is considered to represent another distinct embodiment. Conversely, various features of the present disclosure that are described in the context of a single embodiment for brevity's sake may also be provided separately or in any sub-combination. Finally, while a particular embodiment may be described as a portion of a series of steps or a part of a more general structure, each step or sub-structure or portion may also be considered an independent embodiment in itself.

In general, use of the term “about” indicates approximations that can vary depending on the desired properties sought to be obtained by the disclosed subject matter and is to be interpreted in a context-dependent manner based on functionality. Accordingly, one having ordinary skill in the art will be able to interpret in a context-dependent manner based on functionality. In some instances, the number of significant figures used when expressing a particular value may be a representative technique of determining the variance permitted by the term “about.” In other cases, the gradations in a series of values may be used to determine the range of variance permitted by the term “about.” Further, all ranges in the present disclosure are inclusive and combinable, and references to values stated in ranges include every value within that range.

The present disclosure may be understood more readily by reference to the following examples, all of which form a part of this disclosure. It is to be understood that this disclosure is not limited to the specific products, methods, conditions or parameters described and/or shown herein. Further, the terminology herein is for the purposes of describing particular embodiments by way of example only and is not intended to be limiting unless otherwise specified. Further, it is to be recognized that where the disclosure herein describes an electrochemical cell, capacitor, or other energy storage system, it is to be appreciated that methods for fabricating and operating the electrochemical cell, capacitor, or other energy storage system are also implicitly described.

Exemplary description of illustrative capacitors, their use, assembly thereof, and operating characteristics is provided hereinbelow.

In various embodiments, carbon-based aqueous supercapacitors used for large-scale energy storage are disclosed herein. A large format capacitor cell has a dimension of 15 centimeters (cm) by 15 cm or larger. Large-scale energy storage can be defined as storage of about or greater than 1 kilowatt for 1 hour (i.e., 1 kilowatt-hour (kWh)). Large capacitor cells of the disclosed supercapacitor are easier to manufacture using larger form factor equipment. The disclosed supercapacitors use non-toxic materials and exhibit long life, improved electrical safety, component recyclability, and low-cost. The disclosed supercapacitors are scalable, possess active materials made from renewable, waste, or sequestered carbon, and are low-cost with low-voltage cells that use an aqueous-based electrolyte.

In various embodiments, the cells of the disclosed supercapacitors may be 100 cm by 100 cm or larger, thus, enabling large-scale energy storage. Large-scale energy storage is usable for storing power from a grid source (e.g., power company) and/or local or grid renewable energy sources (e.g., wind, geothermal, solar, tidal, or the like). The disclosed supercapacitors are scalable and may be configured to store 10 kWh, 100 kWh, 1 MWh, 10 mega Wh (MWh), or more.

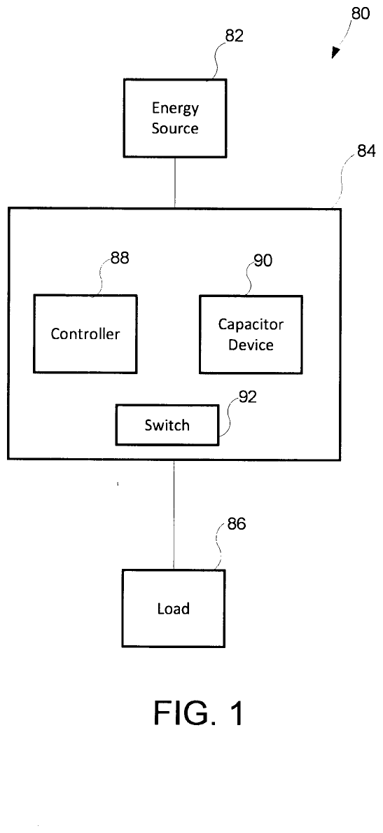

In various embodiments, and referring to FIG. 1, a power charging and discharging system 80 includes an energy source 82, a power storage system 84, and an electrical load 86. The power storage system 84 includes a controller 88, a switch 92, and a capacitor device 90. The energy source 82 supplies electrical power to the power storage system 84. The controller 88 controls the switch 92 to direct the received electrical power to the capacitor device 90 for energy storage. In normal operating conditions, the energy source 82 is coupled to the load 86. However, at times when the energy source 82 is not supplying electrical power to the electrical load 86 due to a power failure or the energy source 82 not being able to produce electrical power, the controller 88 controls the switch 92 to cause the capacitor device 90 provide electrical power to the electrical load 86. The switch 92 may also include a component that allows for manual or automatic switching for how the capacitor cells or stacks of capacitor cells are connected, i.e., parallel or series, depending upon needs of the electrical load 86 and/or the output of the energy source 82.

The energy source 82 may be from a consistent source (e.g., grid power, geothermal, or the like) or an inconsistent source (e.g., renewable energy sources, such as solar, wind, tidal, or the like). The electrical load 86 may include any device or group of devices in need of electrical power. The electrical load 86 may use direct current (DC) or alternating current (AC) power. If the electrical load 86 uses AC power or the energy source supplies AC power, then the power charging and discharging system 80 may include a power conversion device.

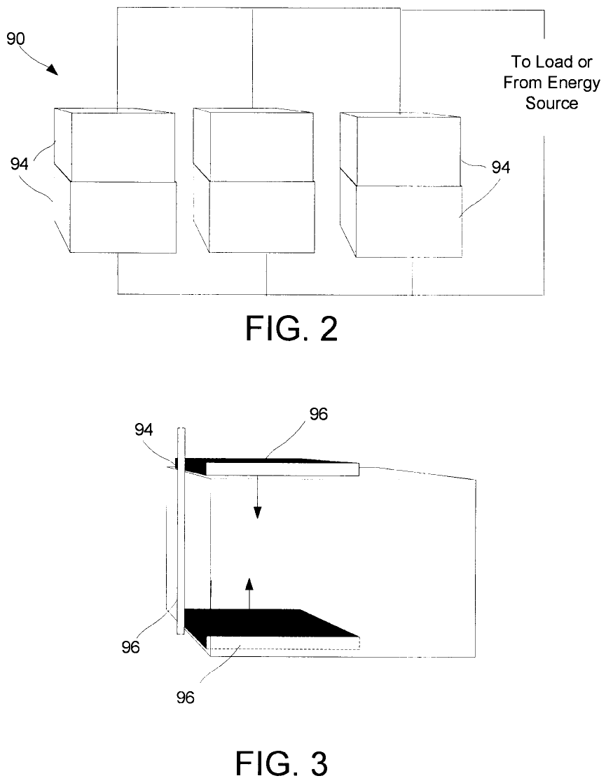

In various embodiments, referring to FIG. 2, the capacitor device 90 may include a plurality of pressure devices 94. Each pressure device 94 allows electrical leads to pass through to stacked capacitor cells located within the pressure devices 94. Each pressure device 94 may be environmentally sealed with additional ports for allowing for environmental control (e.g., heating, cooling, humidity) of the contents. Each pressure device 94 applies pressure to the stacked capacitor cells located therein. In order to maintain electrical contact, the capacitor cells may be subjected to a compressive force or weight as provided by the pressure device 94. The applied force may come from mechanical levers/fasteners, hydraulic or electrical actuators, or the like. Multiple pressure devices 94 may be stacked on one another with leads of one pressure device 94 attaching to leads on an adjacently stacked pressure device 94, such that the capacitor cells within the stacked pressure devices 94 are connected in series. Multiple stacks of pressure devices 94 may be connected in parallel to form the capacitor device 90, which is then connected to the energy source 82 or the load 86.

In various embodiments, referring to FIG. 3, each of the stacked pressure devices 94 or a plurality of the stacked pressure devices 94 includes a clamping device 96 that applies a pressure in a vector direction that is normal to a major surface of capacitor components located within the stacked pressure device 94. The clamping device 96 may be a tie rod system, a spring system, or a comparable mechanical device that can apply pressure from a top surface and a bottom surface. Clamping devices may also be applied in configurations other than vertical, e.g., horizontal.

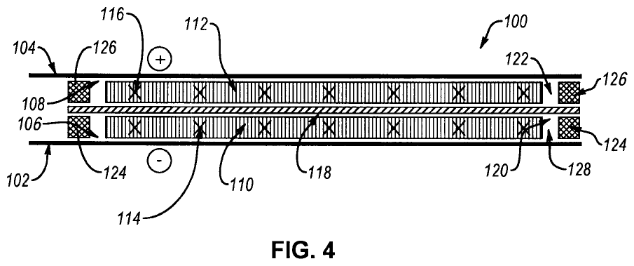

In various embodiments, and referring to FIG. 4, a capacitor cell 100 is usable in the capacitor device 90 shown in FIGS. 2 and 3. The capacitor cell 100 includes two current collectors 102, 104, two current collector interfaces 106, 108, two electrodes 110, 112, two electrode scaffoldings 114, 116, a separator 118, two separator interfaces 120, 122, two gaskets 124 and 126, and an electrolyte 128. A first one of the current collectors 102 is located adjacent to a first one of the electrodes 110. A second one of the current collectors 104 is located adjacent to a second one of the electrodes 112. The electrodes 110, 112 are located on or adjacent to facing surfaces of the current collectors 102, 104 and are sized smaller than the surface area of the current collectors 102, 104. A first one of the gaskets 124 is positioned around the first electrode 110 and adjacent the first current collector 102. A second one of the gaskets 126 is positioned around the second electrode 112 and adjacent to the second current collector 104. The separator 118 is positioned between at least the electrodes 110, 112 and may also be positioned between the gaskets 124, 126. The electrolyte 128 is located in the space between the gaskets 124, 126 and the current collectors 102, 104. A first one of the scaffolding 114 is located within the first electrode 110 and a second one of the scaffolding 116 is located within the second electrode 112. The scaffolding 114, 116 provides structural support to the capacitor cell 100. The scaffolding 114, 116 provides a force that is counter to the force produced by the pressure device 94 (see, e.g., FIGS. 2 and 3).

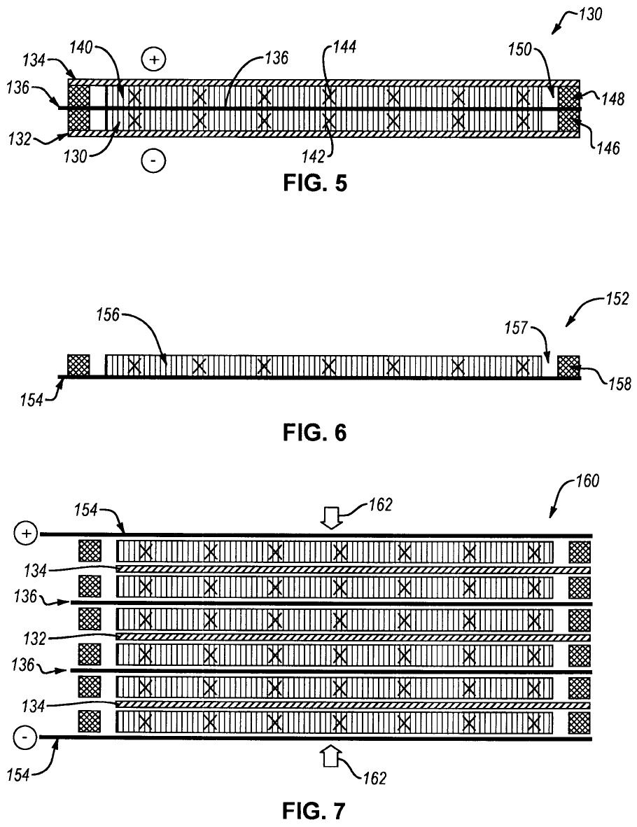

In various embodiments, one example of the capacitor cells usable in the capacitor device 90 is the bipolar cell (i.e., bipolar assembly) 130 of FIG. 5, which includes two outer separators 132, 134 that are located on opposing sides of a current collector 136. A first electrode 138 is located between a first one of the outer separators 132 and the current collector 136 and a second electrode 140 is located between a second one of the outer separators 134 and the current collector 136. This configuration is referred to as a bipolar plate. Additionally, the bipolar cell 130 may include scaffoldings 142, 144 within the respective electrodes 138, 140 and gaskets 146, 148 located between respective ones of the separators 132, 134 and the current collector 136. The gaskets 146, 148 are located external to the electrodes 138, 140. An electrolyte 150 is disposed within the bipolar cell 130.

In various embodiments, referring to FIGS. 6 and 7, in order for the bipolar cell 130 to be used in a series stack 160, the bipolar cell 130 is paired with a monopolar assembly 152. The monopolar assembly 152 includes a current collector 154 (i.e., a monopolar plate), an electrode 156, an electrolyte 157, and a seal (or gasket) 158. The electrode 156 of the monopolar assembly 152 is placed adjacent to the separator 134 of last ones of the bipolar cells 130 in a stack. The current collectors 154 form charge contact points. A clamping device (96; FIG. 3) is attached to outer surfaces of the current collectors 154. The clamping device (96; FIG. 3) applies a pressure 162 forcing the current collectors 154 toward each other. Alternatively, multiple ones of the capacitor cell 100 (as shown in FIG. 4) may be stacked to produce the series stack 160.

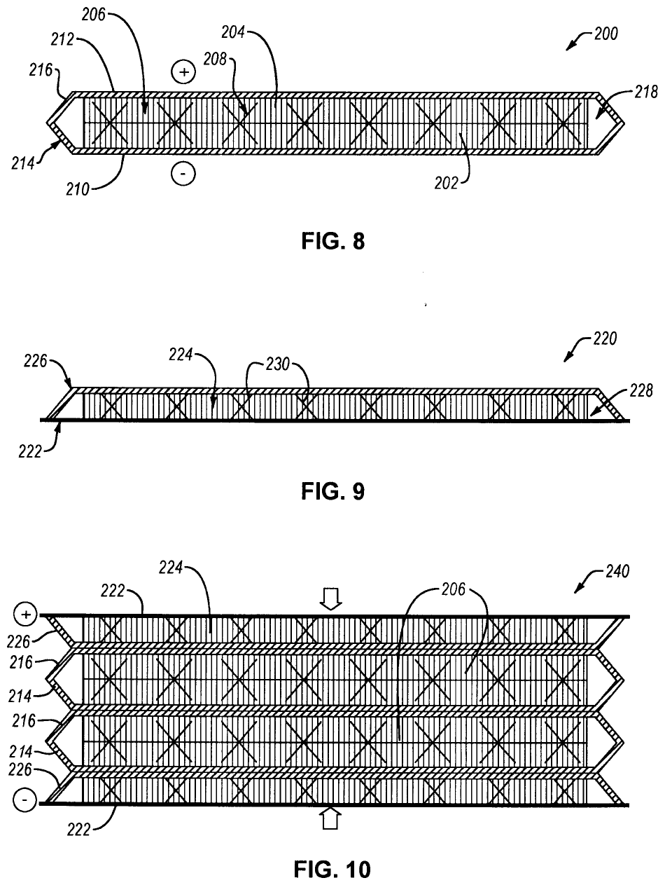

In various embodiments, referring to FIG. 8, a cell 200 includes electrodes 202, 204 that form a unitary conductive body 206. The conductive body 206 may be reinforced with a matrix structure or scaffolding 208 for providing structural assistance to the conductive body 206. First and second separators 210, 212 are disposed adjacent to outer surfaces of the conductive body 206. The unitary conductive body 206 allows for charges to redistribute by direct contact between the electrodes without the participation of a bipolar collector. Ends of the separators 214, 216 are joined to each other to fully enclose the cell 200 and an included electrolyte 218. The separators 214, 216 may be fused to each other or attached with an adhesive or sealant.

In various embodiments, referring to FIGS. 9 and 10, a monopolar assembly 220 is combined with the cell 200 or stacks of the cell 200 to create a series stack 240. The monopolar assembly 220 includes a current collector 222, an electrode 224, and a separator 226. The electrode 224 is located adjacent the surface of the current collector 222. The separator 226 attaches at an outer edge to the current collector 222, thereby containing the electrode 224 while allowing ions to pass through. The separator 226 may be attached to the current collector 222 by an adhesive or a sealant or may be fused to the current collector 222. The monopolar assembly 220 may include scaffolding 230 located within the electrode 224.

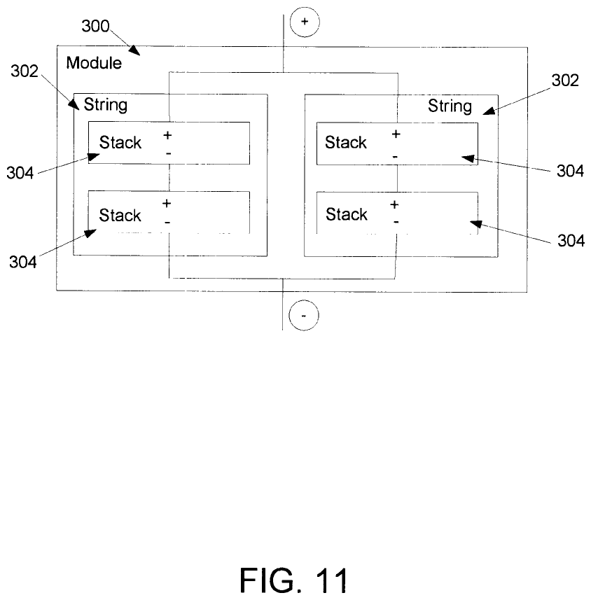

In various embodiments, referring to FIG. 11, a module 300 is an illustrated example of how stacks of capacitor cells can be configured into larger entities in order to become usable for large-scale energy storage. The module 300 may include stacks of capacitor cells 304 that may be connected in series to form strings 302. Two or more strings 302 may be connected in parallel in order to interface with the energy source (82) or the load (86). Furthermore, a plurality of the modules 300 may be assembled into a large-scale energy storage system.

In various embodiments, the current collectors may be made of electrically and thermally conductive material, such as, without limitation, graphite, conductive plastic, or metal. The current collectors may be solid or porous. Furthermore, the current collectors may be flexible or rigid and incorporated in a frame or tray. The current collectors may be a homogeneous material or a composite.

In various embodiments, the current collector interface includes a conductive layer that is well suited for sufficient contact between the electrode and the current collector. The current collector interface may be painted or applied and may be a homogeneous material or a composite. Exemplary materials for the current collector interface include a carbon graphite slurry, a conductive paint, a conductive polymer, a carbon cloth, a conductive binder, or other comparable materials.

In various embodiments, the electrode may be a high surface area conductive form of carbon. The surface area shall be greater than 500 m²/gram. The thickness of the electrodes may be greater than 1 mm, for example, 5, 10, or 20 mm or greater. The carbon electrodes may be in the form of a powder, pellets, fibers, flakes, nanotubes, granules, or other morphologies. The carbon electrodes may be a slurry, a paste, a homogeneous or an inhomogeneous solid liquid or gas mixture.

In various embodiments, the electrodes are supported by the scaffolding which is a structure that is co-located with the electrodes. The scaffolding maintains a uniform thickness of the electrodes. The scaffolding may be a conductive or a non-conductive mesh, matrix, expanded material, or corrugated material, or spacers for use as matrix support. The material used for the scaffolding may be rigid, semi-rigid, or flexible/compliant. The scaffolding maintains an electrode uniform thickness. The scaffolding also provides structural support and allows for improved diffusion of the ions within the porous electrodes, while not entrapping gas that may be generated during operation or construction. If conductive, the scaffolding allows for better distribution of current within the capacitor cell and may have an influence on cell resistance.

In various embodiments, the separator interface is a porous layer that shields the separators from electrode high points that could puncture the separator. The separator interface may be made of plastic mesh, cellulosic mesh, fabric, carbon mesh, cloth, and/or other comparable materials. The separators may be a porous material, homogeneous or composite, non-conductive, that allows the electrolyte and ions to pass through easily, without allowing the electrodes to come in electrical contact with each other. The separator may be hygroscopic, holding the electrolyte within its structure. The separators may be made of plastic, cellulose, paper, leather, cloth, or glass and can be woven or unwoven. The separators may be flexible or semi-rigid. The separators may resist both basic or acidic environments with certain embodiments having a desired neutral pH, alkaline pH, or acidic pH.

In various embodiments, the gaskets may be solid or an open or closed cell foam. The gasket may be formed from material that is a polymer of silicone, acrylic, plastic, or other porous material, such as, without limitation, cardboard. The gasket may be compliant and allow gas to escape the capacitor cell. The gasket may be configured to seal the capacitor cell from an external atmosphere or may serve as the matrix for cell internals.

In various embodiments, an aqueous electrolyte solution may be used as an additive. The electrolyte solution may serve to improve electrical conductivity or influence pH. The electrolyte may include alkaline or alkaline earth metal cations, such as, without limitation, Na+, K+, Ca2+, Mg+2, Zn1+, Zn2+, or other first row transition metal. Corresponding anions may include sulfates, phosphates, carbonates, hydroxides, sulfoxides, phosphorous oxides, metal oxides, nitrates, or chlorates. Example electrolytes may include sodium hydroxide, potassium hydroxide, magnesium hydroxide, calcium hydroxide, sodium bicarbonate, sodium carbonate, sodium sulfate, zinc sulfate, and other anions. The aqueous electrolyte solution may include additive(s) that may be a mixture of two or several substances. The additive may serve the purpose of lowering the freezing point of the solution. The cell may resistant to freezing by having a lower freezing point, by way of accommodating volume changes that occur during freezing, or by draining electrolyte when the cell is stored in the cold.

In various embodiments, the disclosed capacitor cells are optimized for low cost and safety. Traditional capacitors can undergo rapid discharge events that pose a significant safety risk, such as arc-flash or sudden heat release. Such capacitors are designed with low internal resistance, which implies thin layers and short electrical paths for both electrons and ions. The disclosed capacitor design may exchange internal resistance for cost and safety. Accordingly, some embodiments may incorporate increased electrical path lengths thereby forming thicker cells. These thicker cells realize lower cost by decreasing the part count of the system, as it is the plurality of cells that form a system. The implicit higher internal resistance lowers the traditionally high maximum discharge current to lower/safer levels, thereby significantly improving the safety and cost of the system.

In various embodiments, the disclosed capacitor cells use non-metallic materials, such as, without limitation, carbon-based active materials that may have low energy density, about 1, 2, 5, 10, 20, 40, or 100 Wh/kg. Metallic materials are used external to the capacitor cells for connecting the cells to each other and/or to the energy source 82, the switch 92, or the load 86. To that end, these carbon materials are considerably lower in cost when compared to alternatives and therefore, at a scale larger than 1kWh, becomes economically feasible even with the increased material requirements. The large format design requires less human interaction and employs fabrication methods requiring low initial investment, i.e., low capital expenses and low operating expenses. In terms of safety, the disclosed low-voltage cells are designed to prevent fast discharges that avoid dangerous electrical arcs, even if there is an electrical shorting event. Furthermore, the disclosed cells use non-toxic materials, such as carbon, and a water-based electrolyte solution. Such materials can be considered the safest materials as compared to other electrochemical energy storage devices.

The disclosed cell may be oriented horizontally or vertically and may include flat parallel plate or a roll design. Alternative embodiments may have angles obtuse or acute from the horizontal or vertical orientations.

With regard to the cells shown in FIGS. 4-10, upon receiving an electric current from the energy source 82, the shown supercapacitor cells are configured to store electrical energy by shuttling charges to or into the interface between the first non-metallic electrode and the electrolyte solution and at an interface between the second non-metallic electrode and the electrolyte solution.

The following is a non-exhaustive list of examples, which may or may not be claimed, of the subject matter, disclosed herein.

The following portion of this paragraph delineates example 1 of the subject matter, disclosed herein. According to example 1, a supercapacitor cell includes a first non-metallic current collector, a second non-metallic current collector, a first non-metallic electrode disposed adjacent to the first non-metallic current collector, a second non-metallic electrode disposed adjacent to the second non-metallic current collector, a separator disposed between the first non-metallic electrode and the second non-metallic electrode, and an electrolyte solution disposed between the first non-metallic current collector and the second non-metallic current collector.

The following portion of this paragraph delineates example 2 of the subject matter, disclosed herein. According to example 2, which encompasses example 1, above, the supercapacitor cell further includes a partially compressible structure co-located with the first non-metallic electrode and the second non-metallic electrode.

The following portion of this paragraph delineates example 3 of the subject matter, disclosed herein. According to example 3, which encompasses examples 1 or 2, above, the supercapacitor cell also includes a housing that defines an inner cavity. The inner cavity houses the first non-metallic current collector, the second non-metallic current collector, the first non-metallic electrode, the second non-metallic electrode, the separator, and the electrolyte solution. The housing is configured to apply pressure in a direction normal to a major surface of the first non-metallic current collector and a major surface of the second non-metallic current collector.

The following portion of this paragraph delineates example 4 of the subject matter, disclosed herein. According to example 4, which encompasses any of examples 1-3, above, the supercapacitor cell also includes a seal surrounding the first non-metallic electrode, the second non-metallic electrode, the separator, and the electrolyte solution. The seal is located within a space defined between the first non-metallic current collector and the second non-metallic current collector.

The following portion of this paragraph delineates example 5 of the subject matter, disclosed herein. According to example 5, which encompasses any of examples 1-4, above, each one of the first non-metallic current collector and the second non-metallic current collector has a surface area with dimensions of at least 15 centimeters by at least 15 centimeters.

The following portion of this paragraph delineates example 6 of the subject matter, disclosed herein. According to example 6, which encompasses any of examples 1-5, above, the supercapacitor cell is configured to store electrical energy by shuttling charges to or into the interface between the first non-metallic electrode and the electrolyte solution and at an interface between the second non-metallic electrode and the electrolyte solution, in response to receiving an electrical current.

The following portion of this paragraph delineates example 7 of the subject matter, disclosed herein. According to example 7, which encompasses any of examples 1-6, above, the electrolyte solution is an aqueous solution

The following portion of this paragraph delineates example 8 of the subject matter, disclosed herein. According to example 8, which encompasses any of examples 1-7, above, the first non-metallic electrode and the second non-metallic electrode are made of carbon.

The following portion of this paragraph delineates example 9 of the subject matter, disclosed herein. According to example 9, which encompasses any of examples 1-8, above, the first non-metallic electrode and the second non-metallic electrode are porous.

The following portion of this paragraph delineates example 10 of the subject matter, disclosed herein. According to example 10, a stacked capacitor includes a plurality of bipolar cells, a first monopolar assembly, a second monopolar assembly, a plurality of separators, and an electrolyte solution. Each of the bipolar cells includes a first non-metallic current collector, a first non-metallic electrode disposed adjacent to the first non-metallic current collector, and a second non-metallic electrode disposed adjacent to the second non-metallic current collector. The first monopolar assembly includes a second non-metallic current collector and a third non-metallic electrode disposed adjacent to the third non-metallic current collector. The second monopolar assembly includes a third non-metallic current collector and a fourth non-metallic electrode disposed adjacent to the fourth non-metallic current collector. A first one of the plurality of separators is disposed between the first non-metallic electrode and the second non-metallic electrode of adjacently stacked bipolar cells or between the first non-metallic electrode and the third non-metallic electrode. A second one of the plurality of separators is disposed between the second non-metallic electrode or the first non-metallic electrode and the third non-metallic electrode or the fourth non-metallic electrode. The electrolyte solution is disposed around the first non-metallic electrode, the second non-metallic electrode, the third non-metallic electrode, and the fourth non-metallic electrode.

The following portion of this paragraph delineates example 11 of the subject matter, disclosed herein. According to example 11, which encompasses example 10, above, the stacked capacitor further includes a partially compressible structure co-located with the first non-metallic electrode, the second non-metallic electrode, the third non-metallic electrode, and the fourth non-metallic electrode.

The following portion of this paragraph delineates example 12 of the subject matter, disclosed herein. According to example 12, which encompasses any of examples 10 or 11, above, the stacked capacitor further includes a housing that defines an inner cavity. The inner cavity houses the plurality of bipolar cells, the first monopolar assembly, the second monopolar assembly, the plurality of separators, and the electrolyte solution. The housing is configured to apply pressure in a direction normal to a major surface of the second non-metallic current collector and a major surface of the third non-metallic current collector.

The following portion of this paragraph delineates example 13 of the subject matter, disclosed herein. According to example 13, which encompasses any of examples 10-12, above, the stacked capacitor further includes a plurality of seals. Each seal surrounds at least one of the first non-metallic electrode, the second non-metallic electrode, the third non-metallic electrode, or the fourth non-metallic electrode.

The following portion of this paragraph delineates example 14 of the subject matter, disclosed herein. According to example 14, which encompasses any of examples 10-13, above, each one of the second non-metallic current collector and the third non-metallic current collector has a surface area with a dimension of at least 15 centimeters by at least 15 centimeters and the stacked capacitor has a thickness dimension being at least 2 millimeters.

The following portion of this paragraph delineates example 15 of the subject matter, disclosed herein. According to example 15, which encompasses any of examples 10-14, above, in response to receiving an electrical current, the stacked capacitor is configured to store electrical energy by shuttling charges to or into the interface between the first non-metallic electrode and the electrolyte solution, at an interface between the second non-metallic electrode and the electrolyte solution, at an interface between the third non-metallic electrode and the electrolyte solution, and at an interface between the fourth non-metallic electrode and the electrolyte solution.

The following portion of this paragraph delineates example 16 of the subject matter, disclosed herein. According to example 16, which encompasses any of examples 10-15, above, the capacitor has an energy density between, and inclusive of, at least 1 Watt-hour per kilogram (Wh/kg) and at least 10 Wh/kg.

The following portion of this paragraph delineates example 17 of the subject matter, disclosed herein. According to example 17, which encompasses any of examples 10-16, above, the electrolyte solution is an aqueous solution.

The following portion of this paragraph delineates example 18 of the subject matter, disclosed herein. According to example 18, which encompasses any of examples 10-17, above, the first non-metallic electrode, the second non-metallic electrode, the third non-metallic electrode, and the fourth non-metallic electrode are made of carbon.

The following portion of this paragraph delineates example 19 of the subject matter, disclosed herein. According to example 19, which encompasses any of examples 10-18, above, the first non-metallic electrode, the second non-metallic electrode, the third non-metallic electrode, and the fourth non-metallic electrode are porous.

The following portion of this paragraph delineates example 20 of the subject matter, disclosed herein. According to example 20, a system includes a controller, a plurality of stacked capacitors coupled in parallel or series, and a switch in signal communication with the controller and electrically connected between the plurality of stacked capacitors and an electrical load or an energy source. Each one of the plurality of stacked capacitors includes a plurality of bipolar cells, a first monopolar assembly, a second monopolar assembly, a plurality of separators, and an electrolyte solution. The bipolar cells includes a first non-metallic current collector, a first non-metallic electrode disposed adjacent to the first non-metallic current collector, and a second non-metallic electrode disposed adjacent to the second non-metallic current collector. The first monopolar assembly includes a second non-metallic current collector and a third non-metallic electrode disposed adjacent to the third non-metallic current collector. The second monopolar includes a third non-metallic current collector and a fourth non-metallic electrode disposed adjacent to the fourth non-metallic current collector. The plurality of separators includes a first one of the plurality of separators disposed between the first non-metallic electrode and the second non-metallic electrode of adjacently stacked bipolar cells or between the first non-metallic electrode and the third non-metallic electrode and a second one of the plurality of separators disposed between the second non-metallic electrode or the first non-metallic electrode and the third non-metallic electrode or the fourth non-metallic electrode. The electrolyte solution is disposed around the first non-metallic electrode, the second non-metallic electrode, the third non-metallic electrode, and the fourth non-metallic electrode.

The present disclosure may be understood more readily by reference to the following examples, all of which form a part of this disclosure. Further, the terminology herein is for the purposes of describing particular embodiments by way of example only and is not intended to be limiting unless otherwise specified. Similarly, unless specifically stated otherwise, any description herein directed to a composition is intended to refer to both solid and liquid versions of the composition, including materials and electrolytes containing the composition, and electrochemical cells, capacitors, and other energy storage systems containing such materials and electrolytes. Further, it is to be recognized that where the disclosure herein describes an electrochemical cell, capacitor, or other energy storage system, it is to be appreciated that methods for fabricating and operating the electrochemical cell, capacitor, or other energy storage system are also implicitly described.

It is also to be appreciated that certain features of the present disclosure may be described herein in the context of separate embodiments for clarity purposes but may also be provided in combination with one another in a single embodiment. That is, unless obviously incompatible or specifically excluded, each individual embodiment is deemed to be combinable with any other embodiment(s) and the combination is considered to represent another distinct embodiment. Conversely, various features of the present disclosure that are described in the context of a single embodiment for brevity's sake may also be provided separately or in any sub-combination. Finally, while a particular embodiment may be described as a portion of a series of steps or a part of a more general structure, each step or sub-structure or portion may also be considered an independent embodiment.

Unless stated otherwise, it is to be understood that each individual element in the list and every combination of individual elements in that list is to be interpreted as a distinct embodiment. For example, a list of embodiments presented as “A, B, or C” is to be interpreted as including the embodiments “A,” “B,” “C,” “A or B,” “A or C,” “B or C” or “A, B, or C.”

In the present disclosure, the singular forms of the articles “a,” “an,” and “the” also include the corresponding plural references, and reference to a particular numerical value, unless the context clearly indicates otherwise. Thus, for example, reference to “a material” is a reference to at least one of such materials and equivalents thereof.

Although the disclosure has been described with reference to the disclosed embodiments, those skilled in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description. In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A supercapacitor cell comprising:
a first non-metallic current collector;
a second non-metallic current collector;
a first non-metallic electrode disposed adjacent to the first non-metallic current collector;
a second non-metallic electrode disposed adjacent to the second non-metallic current collector;
a separator disposed between the first non-metallic electrode and the second non-metallic electrode; and
an electrolyte solution disposed between the first non-metallic current collector and the second non-metallic current collector.

2. The supercapacitor cell of claim 1, further comprising a partially compressible structure co-located with the first non-metallic electrode and the second non-metallic electrode.

3. The supercapacitor cell of claim 2, further comprising a housing that defines an inner cavity, wherein the inner cavity houses the first non-metallic current collector, the second non-metallic current collector, the first non-metallic electrode, the second non-metallic electrode, the separator, and the electrolyte solution, and wherein the housing is configured to apply pressure in a direction normal to a major surface of the first non-metallic current collector and a major surface of the second non-metallic current collector.

4. The supercapacitor cell of claim 1, further comprising a seal surrounding the first non-metallic electrode, the second non-metallic electrode, the separator, and the electrolyte solution, and located within a space defined between the first non-metallic current collector and the second non-metallic current collector.

5. The supercapacitor cell of claim 1, wherein each one of the first non-metallic current collector and the second non-metallic current collector has a surface area with dimensions of at least 15 centimeters by at least 15 centimeters.

6. The supercapacitor cell of claim 1, wherein in response to receiving an electrical current, the supercapacitor cell is configured to store electrical energy by shuttling charges to or into the interface between the first non-metallic electrode and the electrolyte solution and at an interface between the second non-metallic electrode and the electrolyte solution.

7. The supercapacitor cell of claim 1, wherein the electrolyte solution is an aqueous solution.

8. The supercapacitor cell of claim 1, wherein the first non-metallic electrode and the second non-metallic electrode are made of carbon.

9. The supercapacitor cell of claim 8, wherein the first non-metallic electrode and the second non-metallic electrode are porous.

10. A stacked capacitor comprising:
a plurality of bipolar cells, each of the bipolar cells comprising:
a first non-metallic current collector;
a first non-metallic electrode disposed adjacent to the first non-metallic current collector; and
a second non-metallic electrode disposed adjacent to the second non-metallic current collector;
a first monopolar assembly comprising:
a second non-metallic current collector; and
a third non-metallic electrode disposed adjacent to the second non-metallic current collector;
a second monopolar assembly comprising:
a third non-metallic current collector; and
a fourth non-metallic electrode disposed adjacent to the third non-metallic current collector;
a plurality of separators, wherein:
a first one of the plurality of separators is disposed between the first non-metallic electrode and the second non-metallic electrode of adjacently stacked bipolar cells or between the first non-metallic electrode and the third non-metallic electrode; and
a second one of the plurality of separators is disposed between the second non-metallic electrode or the first non-metallic electrode and the third non-metallic electrode or the fourth non-metallic electrode; and
an electrolyte solution disposed around the first non-metallic electrode, the second non-metallic electrode, the third non-metallic electrode, and the fourth non-metallic electrode.

11. The stacked capacitor of claim 10, further comprising a partially compressible structure co-located with the first non-metallic electrode, the second non-metallic electrode, the third non-metallic electrode, and the fourth non-metallic electrode.

12. The stacked capacitor of claim 11, further comprising a housing that defines an inner cavity, wherein the inner cavity houses the plurality of bipolar cells, the first monopolar assembly, the second monopolar assembly, the plurality of separators, and the electrolyte solution, and wherein the housing is configured to apply pressure in a direction normal to a major surface of the second non-metallic current collector and a major surface of the third non-metallic current collector.

13. The stacked capacitor of claim 10, further comprising a plurality of seals, wherein each seal surrounds at least one of the first non-metallic electrode, the second non-metallic electrode, the third non-metallic electrode, or the fourth non-metallic electrode.

14. The stacked capacitor of claim 10, wherein each one of the second non-metallic current collector and the third non-metallic current collector has a surface area with a dimension of at least 15 centimeters by at least 15 centimeters and the stacked capacitor has a thickness dimension being at least 2 millimeters.

15. The stacked capacitor of claim 10, wherein in response to receiving an electrical current, the stacked capacitor is configured to store electrical energy by shuttling charges to or into the interface between the first non-metallic electrode and the electrolyte solution, at an interface between the second non-metallic electrode and the electrolyte solution, at an interface between the third non-metallic electrode and the electrolyte solution, and at an interface between the fourth non-metallic electrode and the electrolyte solution.

16. The stacked capacitor of claim 15, wherein the capacitor has an energy density between, and inclusive of, at least 1 Watt-hour per kilogram (Wh/kg) and at least 10 Wh/kg.

17. The stacked capacitor of claim 10, wherein the electrolyte solution is an aqueous solution.

18. The stacked capacitor of claim 10, wherein the first non-metallic electrode, the second non-metallic electrode, the third non-metallic electrode, and the fourth non-metallic electrode are made of carbon.

19. The stacked capacitor of claim 18, wherein the first non-metallic electrode, the second non-metallic electrode, the third non-metallic electrode, and the fourth non-metallic electrode are porous.

20. A system comprising:
a controller;
a plurality of stacked capacitors coupled in parallel or series, wherein each one of the plurality of stacked capacitors comprises:
a plurality of bipolar cells, wherein each one of the bipolar cells comprises:
a first non-metallic current collector;
a first non-metallic electrode disposed adjacent to the first non-metallic current collector; and
a second non-metallic electrode disposed adjacent to the second non-metallic current collector;
a first monopolar assembly comprising:
a second non-metallic current collector; and
a third non-metallic electrode disposed adjacent to the second non-metallic current collector;
a second monopolar assembly comprising:
a third non-metallic current collector; and
a fourth non-metallic electrode disposed adjacent to the third non-metallic current collector;
a plurality of separators comprising:
a first one of the plurality of separators disposed between the first non-metallic electrode and the second non-metallic electrode of adjacently stacked bipolar cells or between the first non-metallic electrode and the third non-metallic electrode; and
a second one of the plurality of separators disposed between the second non-metallic electrode or the first non-metallic electrode and the third non-metallic electrode or the fourth non-metallic electrode; and
an electrolyte solution disposed around the first non-metallic electrode, the second non-metallic electrode, the third non-metallic electrode, and the fourth non-metallic electrode; and
a switching device in signal communication with the controller and electrically connected between the plurality of stacked capacitors and an electrical load or an energy source or connected between the plurality of stacked capacitors for controlling how the stacked capacitors are connected to each other.
